(19) United States
(12) Patent Application Publication
(10) Pub. No.: US 2007/0232104 A1
(43) Pub. Date: Oct. 4, 2007

(54) Electrical connector

(75) Inventor: Ted Ju, Anloku (TW)

Correspondence Address: BIRCH STEWART KOLASCH & BIRCH, PO BOX 747, FALLS CHURCH, VA, 22040-0747, US

(73) Assignee: Lotes Co., Ltd

(21) Appl. No.: 11/582,300

(22) Filed: Oct. 18, 2006

(30) Foreign Application Priority Data
Apr. 3, 2006 (TW) 095205541

(51) Int. Cl. H01R 29/00

(52) U.S. Cl. 439/188

(57) ABSTRACT

The invention relates to an electrical connector, with a simple structure, for increasing densification of electrical conducting terminals. To achieve the objective discussed above, the electrical connector includes an insulating housing with a plurality of contact accommodating cavities and an electrical conducting terminal. The electrical conducting terminal, accommodated in one of the cavities, includes a main portion, a first connect arm, and a second connect arm. The first connect arm extends to form a conductive portion for conductively contacting with a first electrical component. The second connect arm extends to form a hook portion for hooking with an insulator. The other side of the main portion extends to form a contact portion for conductively conducting with a second electrical component. Compared with prior art, the electrical conducting terminal according to the invention has a simple structure and can increase densification of terminals.

### BACKGROUND OF THE INVENTION

1. Field of the Invention

The present invention relates to an electrical connector.

2. Description of the Prior Art

Referring to FIG. 1, FIG. 1 is a schematic of an electrical conducting terminal according to prior art. An electrical connector, according to the Chinese patent CN200320117939.3, includes an insulating housing having a plurality of cavities and an electrical conducting terminal 1 having a base portion 10, a conductive portion 12, and a flexible portion 14. The electrical conducting terminal 1 is accommodated in the insulating housing. The conductive portion 12 and the flexible portion 14 are both formed by extending one end of the base portion 10. The flexible portion 14 includes thereon a curving portion 16 formed by extending from a side wall of the base portion 10. The end of the curving portion 16 further extends to form a bending portion 18. The bending portion 18 bends from the curving portion 16 with a specific angle. The base portion 10 forms a right angle with the curving portion 16. Due to the complex structure of this type of electrical conducting terminal and the presence of a right angle between the base portion 10 and the curving portion 16, densification of the terminals is difficult.

Accordingly, a scope of the present invention is to provide a novel electrical connector to resolve the problems described above.

### SUMMARY OF THE INVENTION

A scope of the invention is to provide an electrical connector with a simple structure and can be used for increasing the level of densification of the electrical conducting terminals.

In order to achieve the scope described above, the electrical connector includes an insulating housing having a plurality of cavities and an electrical conducting terminal accommodated in one of those cavities. The electrical conducting terminal includes a main portion, a first connecting arm, and a second connecting arm. The first connecting arm and the second connecting arm both extend from one side of the main portion. The first connecting arm extends to form a conductive portion for conductively contacting with a first electrical component. The second connecting arm extends to form a hook portion for hooking with an insulator. The other side of the main portion extends to form a contact portion for conductively conducting with a second electrical component.

Comparing with prior art, the electrical connector, according to the invention, has a simple structure and is capable of increasing the level of densification of electrical conducting terminals.

The advantage and spirit of the invention may be understood by the following recitations together with the appended drawings.

### BRIEF DESCRIPTION OF THE APPENDED DRAWINGS

FIG. 1 is a schematic of an electrical conducting terminal according to prior art.

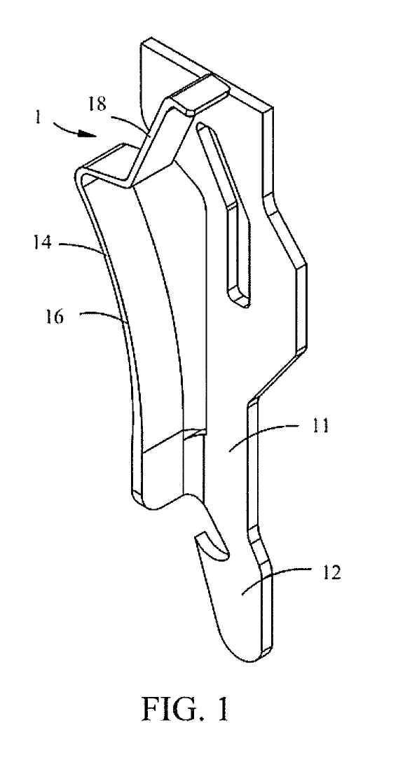

FIG. 2 is an assembly view of an electrical conducting terminal and an insulator according to the invention.

FIG. 3 is a schematic of the electrical conducting terminal according to the invention.

FIG. 4 is a front view of an electrical connector with a tin ball, according to the invention.

FIG. 5 is a sectional view of the insulator according to the invention.

FIG. 6 is an assembly of the electrical connector according to a second embodiment of the invention.

### DETAILED DESCRIPTION OF THE INVENTION

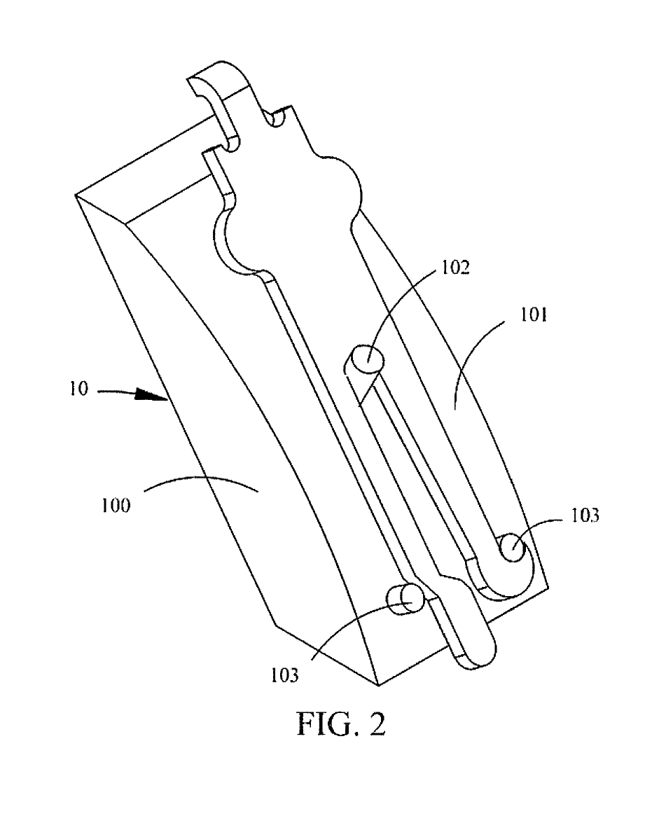

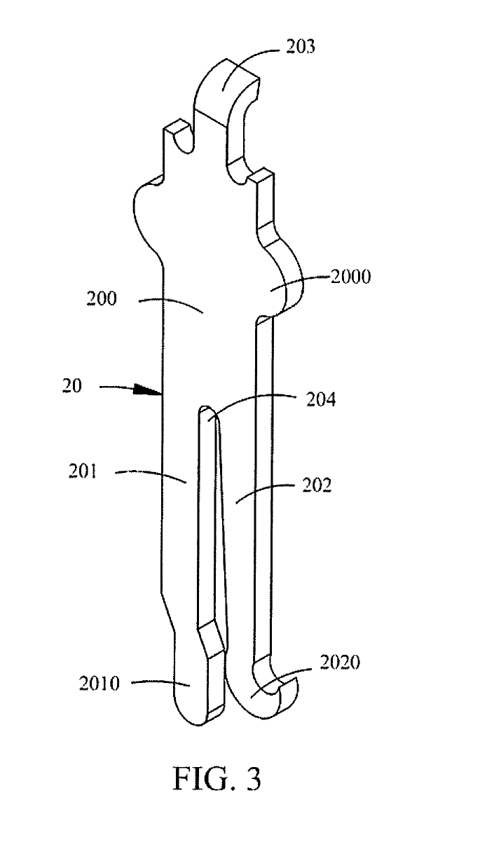

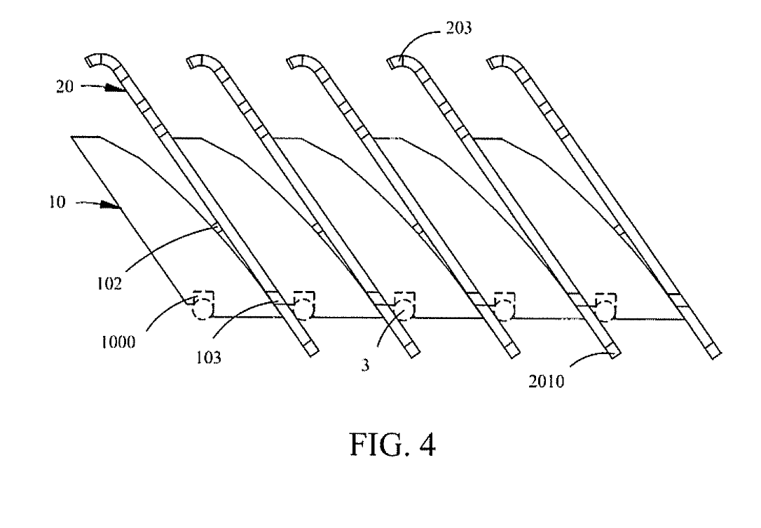

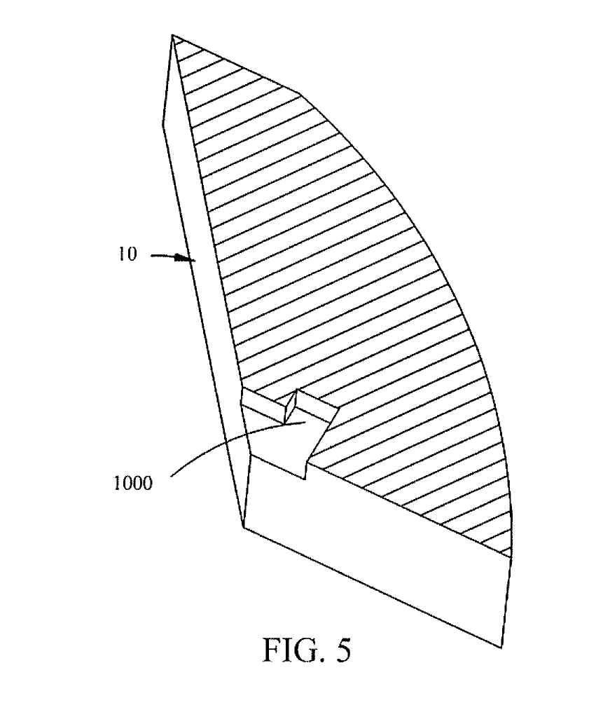

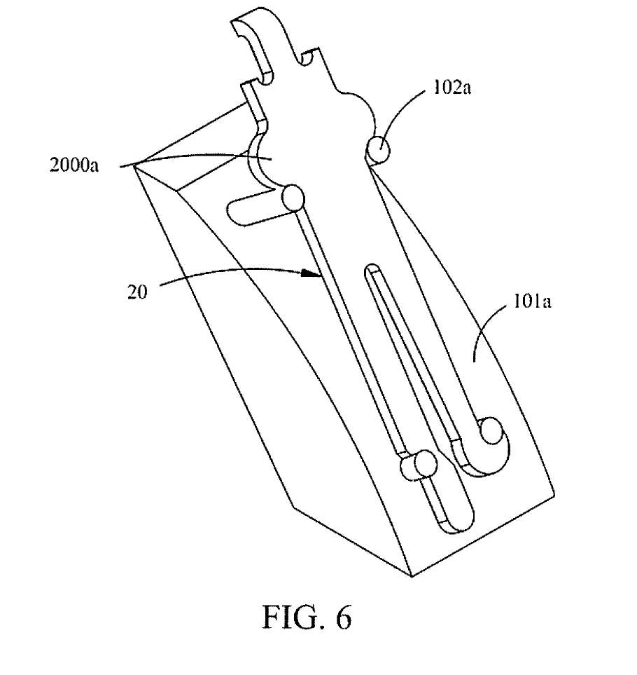

Referring to FIG. 2 through FIG. 6, FIG. 2 is an assembly view of an electrical conducting terminal and an insulator according to the invention; FIG. 3 is a schematic of the electrical conducting terminal according to the invention; FIG. 4 is a front view of an electrical connector with a tin ball according to the invention; FIG. 5 is a sectional view of the insulator according to the invention; and FIG. 6 is an assembly of the electrical connector according to a second embodiment of the invention. The electrical connector, according to the invention, includes an insulating housing having a plurality of cavities and a plurality of electrical conducting terminals 20 accommodated in one of the cavities. The insulating housing is formed with an array of a plurality of insulators 10. The cavities are formed by adjacent insulators 10.

An insulator 10 includes a base 100 and a resisting wall 101 on one side of the base 100. The lower part of the base 100 contains a solder, which corresponds to the electrical conducting terminal 20, for soldering the electrical conducting terminal with a circuit board. (In this embodiment, the solder is a tin ball 3.)

A tin ball retaining slot 1000, formed in the lower part of the base 100, is for retaining the lead 3 within the slot.

The resisting wall 101, being arc-shaped, is attached onto by the electrical conducting terminal 20 after being formed. Furthermore, a blocker 102, being located basically in the middle of the resisting wall 101, is used for preventing the electrical conducting terminal 20 from slipping excessively downwards. The lower part of the resisting wall 101 extends to form two ridges 103, which are pressed against the insulator 10 ahead to form a cavity between the resisting wall 101 and the insulator 10 ahead, for accommodating the electrical conducting terminal 20 in the cavity.

The electrical conducting terminal 20, being substantially pillar-shaped, includes a main portion 200, a first connecting arm 201, a second connecting arm 202, and a contact portion 203. The first connecting arm 201 and the second connecting arm 202 are formed by the extension from one side of the main portion 200. The contact portion 203, not being on the same plane as the main portion 200, is formed by the extension from another side of the main portion 200. The contact portion 203 bends from the main portion 200 by a specific angle. The contact portion 203 is used for conductively contacting with a second electrical component. The main portion 200 has at least one protruding portion 2000 which is formed on one side of the main portion 200 protruding outward. The first connecting arm 201 extends to form a conductive portion 2010 for conductively conducting with a first electrical component. In this embodiment, the conductive portion 2010 is soldered with a surface of a circuit board (not shown in figures). The second connecting arm 202 extends to form a hook portion 2020 for hooking with one of the ridges 103. This prevents the electrical conducting terminal 20 from detaching from the insulator 10. Moreover, a gap 204, being between the first connecting arm 201 and the second connecting arm 202, has a semicircle upper part that can be used for coping with the blocker 102 to prevent the electrical conducting terminal 20 from slipping excessively downwards.

After assembly, the conductive portion 2010 and the retaining slot 1000 for the tin ball 3 cooperatively clasp the tin ball 3.

Referring to FIG. 6, FIG. 6 is an assembly of the electrical connector according to a second embodiment of the invention. The second embodiment of the invention differs from the first embodiment in that the blocker 102a described is substantially located on the upper part of the resisting wall 101a, and the blocker 102a copes with the protruding portion 2000a, for preventing the electrical conductive terminal 20 from slipping excessively downwards and for lowering stress concentration of the electrical conductive terminal 20 to reduce fatigue failure and to acquire greater normal force.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electrical connector comprising an insulating housing having a plurality of cavities and an electrical conducting terminal accommodated in one of the cavities, wherein the electrical conducting terminal comprises a main portion, a first connecting arm and a second connecting arm both extend from one side of the main portion, the first connect arm extends to form a conductive portion for conductively contacting with a first electrical component, the second connect arm extends to form a hook portion for hooking with an insulator, and the other side of the main portion extends to form a contact portion for conductively conducting with a second electrical component.

2. The electrical connector of claim 1, wherein the contact portion and the main portion are respectively on different planes.

3. The electrical connector of claim 2, wherein the contact portion bends from the main portion by a specific angle.

4. The electrical connector of claim 1, wherein at least one side of the main portion protrudes outwards to form a protruding portion.

5. The electrical connector of claim 4, wherein the protruding portion is capable of being against an insulator, so as to prevent the electrical conducting terminal from moving excessively downwards.

6. The electrical connector of claim 1, wherein a side wall of the cavity of the insulating housing has a blocker for blocking the electrical conducting terminal from moving downwards.

7. The electrical connector of claim 1, wherein the cavity of the electric conducting terminal has a resisting wall on which the electrical conducting terminal attaches after being forced.

8. The electrical connector of claim 7, wherein the resisting wall is arc-shaped.

9. The electrical connector of claim 1, wherein the conductive portion is soldered with a surface of a circuit board.

10. The electrical connector of claim 1, wherein the electric conducting terminal is obliquely accommodated in the insulating housing.

11. The electrical connector of claim 1, wherein the insulating housing has a solder, corresponding to the electrical conducting terminal, for soldering the electrical conducting terminal with a circuit board.
